(19) United States
(12) Patent Application Publication
(10) Pub. No.: US 2024/0280321 A1
(43) Pub. Date: Aug. 22, 2024

(54) IMPROVED HYBRID SMELTING SYSTEM

(71) Applicant: EESTECH EUROPE HOLDINGS BV, Amsterdam (NL)

(72) Inventors: Chad Daniel LEHMAN, Elkhart, IN (US); Murray James BAILEY, Auckland (NZ)

(21) Appl. No.: 18/570,628

(22) PCT Filed: Jun. 14, 2022
(86) PCT No.: PCT/IB2022/055499

§ 371 Date: Dec. 14, 2023

(30) Foreign Application Priority Data
Jun. 15, 2021 (GB) 2108524.6

(51) Int. Cl. F27B 3/20; F27D 11/06; F27D 11/08; F27D 19/00

(52) U.S. Cl. CPC F27B 3/20; F27D 11/06; F27D 11/08; F27D 19/00; F27D 2019/0037; F27M 2001/10; F27M 2001/16; F27M 2002/11; F27M 2003/13

(57) ABSTRACT

The present invention relates to improvements to an induction smelting process. It relates to a hybrid combination of plasma over induction for a superefficient continuous smelting process; and real-time monitoring and adjustment of the smelting process. Disclosed is a hybrid smelting system comprising a real-time controller and a reduction zone in which plasma over induction heating continuously smelt feed material(s) fed into the reduction zone. Slag and reduced metals (alloy) are discharged under supervision of the real-time controller.

### FIELD OF THE INVENTION

The present invention relates to improvements to an induction smelting process. In particular it relates to improved means to control a hybrid combination of plasma over induction for a superefficient continuous smelting process; and real-time monitoring and adjustment of the smelting process.

Among the advantages are the removal of residual metals from ores, concentrates, and slag waste; increased metal unit yields; the ability to smelt fine powder materials; real-time analysis of feed material for precise addition of flux and reductant; real-time management of the smelting process through a back scatter x-ray unit; and continuous throughput smelting.

It is a particular advantage of the present invention that the system enables a significant reduction in power consumption, for example, a reduction of at least fifty percent over current smelting processes.

### BACKGROUND

In a smelting a metal oxide, reducing agent, and flux is mixed in a furnace where chemical reactions induced by heat produce molten metal. The metal oxide, reducing agent, and flux are supplied as solid feed materials into the furnace. The metal oxide feed material may be a crushed ore. The reducing agent feed material may be a carbonaceous material such as coking coal. In the chemical reactions, the reducing agent reduces the metal oxide to separate the oxygen from molten metal. The flux feed material (for example lime or dolomite) is used to catalyze the chemical reactions and chemically bind to unwanted impurities or reaction products.

Molten byproducts of the chemical reactions known as slag float above the molten metal in the furnace. Above the slag is a space in the furnace where gases from the chemical reactions accumulate. Air or oxygen enriched air is blown through a lance into the space to burn off the reaction gases. This produces heat which helps to keep the slag and metal molten in the furnace. An off-gas duct leads out of the space to take away the burned off reaction gases.

The mining and minerals processing industries use AC/DC electric arc furnace technology to smelt lumpy ores, fine ores, and concentrated ores into various base metal products. AC/DC electric arc furnaces can consume up to 4,500 KW of electrical energy per ton of smelted metal for chromite ore and up to 6500 KW of energy per ton for other ores due to elevated levels of alumina and/or silica oxides present in the smelting concentrate.

The smelted metal in an AC/DC electric arc furnace is kept molten by the formation of a thick head of insulating slush-like slag on top of the molten metal. A solid feed material of quartz rock (silica) may be supplied into the furnace to increase the thickness of the slag. The slag must be kept molten which also requires a considerable amount of energy.

AC/DC electric arc furnaces require large amounts of power and produce a significant carbon footprint.

Blast furnaces also produce a substantial carbon footprint. Blast furnaces are heated by thermal coal of specific grades (i.e. that are low in sulfur, phosphorus, and volatiles) and coking coal to reduce the metal oxides into metal. Some or all of the coal may be crushed or pulverized into specific sizes of lumpy or pelletized materials and gravity fed into the furnace from the top. Some or all of the coal may be pulverized coal and blown into the bottom of the blast furnace.

The feed materials must remain gas permeable allowing off gasses and air to flow upwards through the feed material and egress from the top of the furnace.

If the feed material is too fine or the lumpy material breaks up in the furnace, it will inhibit the flow of gases and air, which chokes the combustion process and can cause the molten contents at the bottom of the furnace to solidify, stopping the smelting process. If this occurs, the furnace must be shut down and allowed to cool. This cooling can take over a week. Once cool, all solidified materials must be removed, and the furnace liner repaired before the furnace can be restarted. This process takes considerable time and money.

Induction furnaces achieve higher energy efficiency than blast and arc furnaces. Induction furnaces produce electromagnetic fields that couple with conductive materials such as metals and carbon. These electromagnetic fields are contained within the furnace body by shunting bars that are placed around the induction coils to focus the electromagnetic fields to the material to be smelted in the centre of the furnace. The electromagnetic coupling with conductive materials enables induction furnaces to transmit energy directly into the material to be smelted producing rapid melt rates.

However, certain limiting factors restrict the broad use induction furnaces: the magnetic field in an induction furnace can only couple with conductive materials like metals and carbon, thus restricting potential smelting applications; for example, the electromagnetic field from the induction furnace does not couple with non-conductive metal oxides (such as silica, alumina, magnesium, etc.) and slag contents must comprise less than six percent thereby limiting its use as a primary smelting furnace; further, slag materials may need to be skimmed or scraped off the top of the molten metal on a frequent basis because the slag cools and forms a hard crust, which interferes with the smelting or melting process (the crust creates a seal trapping gas producing molten metal underneath which can super heat and melt through the refractory lining and into the water-cooled induction coils causing the furnace to explode or it causes a gas pressure spike, which can also lead to a furnace explosion).

To avoid a hard crust forming, fluxes are added to the smelt to lower the slag melting temperature to the melting temperature of the metal being processed and skimming the slag off or scraping the slag out of the furnace. However, melting the slag and keeping it molten relies on radiant heat from the molten metal in the furnace. Such dependency on the heat transfer of radiant heat from the molten metal limits the amount of slag an induction furnace can safely handle. Thus, smelting is done in small batches on top of pre-melted metal in the induction furnace (known as heal smelting), which requires constant slag skimming. As such this process is inefficient.

A further constraint relates to the limitation of power supply units to electrical frequencies of 2-20 Hz for industrial sized induction furnaces (production capacity of over five ton per hour). Further, such low frequency magnetic fields require lumpy sized feed material of 40 mm or larger for coupling and thus cannot couple with fine metal concentrates produced from metal recovery and or concentration processes.

This limiting factor can be overcome by starting the furnace with a “starter” ingot produced from the required metal ahead of time by other means. The ingot melts to form a molten pool of metal in the furnace that radiates heat into the fine concentrate and eventually melts it. However, the high risk of furnace freeze remains as it is the radiant heat from the molten metal that heats the slag, only at the slag metal interface and not by the electromagnetic field, therefore the potential of a furnace freeze remains a critical trigger point condition.

Thus, while traditional induction furnaces are efficient tools for re-melting relatively clean metal for the foundry industry they are less suitable as a primary smelting furnace for fine metal concentrates, lumpy ores and ore concentrates. This is due in particular to their inability to electromagnetically couple with fine materials and directly heat slag or non-conductive materials. Additionally, traditional induction furnaces do not have a means of continuously discharging the produced slag and metal to maintain a continuous operation.

Scanning systems such as back scatter scanning are known methods for monitoring feed as described for example in publications WO-A1-2008/142704 and WO-A1-2016/124823. Other known monitoring methods include the practice of batch analysis, or real time continuous analysis.

Publication US-A1-2005/0120754 describes hybrid smelting systems which comprise a furnace with induction coils, a feed aperture and vertically mobile twin plasma electrodes spaced apart in a furnace lid. In publication WO-A1-96/17093 an induction smelting furnace comprises coils and plasma torch assembly, where two angled and adjustable electrodes are placed directly below the inlet and spaced apart to form a plasma field between them.

Publication WO-A1-2008/142704 describes feed preparation systems whereby feeds (ore, reductant, and flux feeds) undergo a mixing and pelletizing stage.

However, while such publications address certain inherent inefficiencies in the smelting process, they do not achieve efficiencies required for burgeoning contemporary economic and environmental standards: the respective smelting process remains discontinuous and consumes significant amounts of energy.

The present invention provides a system for super energy-efficient, continuous smelting. that consumes at least 50-70% less power than traditional furnace systems. In an illustrative embodiment, the present invention consumes 58% less power.

### SUMMARY OF THE INVENTION

According to a first aspect, there is a hybrid smelting system comprising a hybrid combination of plasma over induction. The hybrid smelting system may comprise a real-time controller and a reduction zone in which plasma over induction heating continuously smelt infeed material(s) fed into the reduction zone and discharges slag and reduced metals (alloy) under supervision of the real time controller.

The hybrid smelting system effects a super-efficient, continuous smelting process which significantly reduces power consumption.

According to another aspect a hybrid smelting system comprising a hybrid combination of plasma over induction including real-time monitoring and means to adjust operating parameters of the hybrid smelting system. Operating parameters may include: a reduction zone; raw feed material; amounts and blends of concentrate versus reductant versus flux. To adjust the operating parameters the hybrid smelting system may comprise an imaging device to inspect materials being processed in the furnace; a tap configured for continual tapping of materials; and a crusher configured for granulation of finished products.

According to another aspect, there is a hybrid smelting system comprising a hybrid combination of plasma over induction including a residual metal recovery device. A re-smelting step may be enabled by the residual metal recovery device whereby almost all residual metals are recovered from slag waste.

The hybrid smelting system may incorporate means to: detect and monitor the level of content and/or indicate a predetermined level; to instigate discharge of the molten slag at one or more out-feeds when the contents in the furnace reach a predetermined level; and to receive and continuously analyze information from a sensor and/or scanning system (e.g. for control batch analysis of the ore concentrate, temperature, discharge rate, the height of at least one agitator and the temperature of heating elements integral to the agitator). The hybrid smelting system may incorporate means to configure one or more blades/susceptors for stirring.

The hybrid smelting system enables a super-efficient, continuous smelting process using a hybrid combination of plasma over induction whereby continuous smelting of all types of materials— conductive or non-conductive materials— is possible using variable feed ranging in size from ultra-fine powder to lumps for or above 40 mm.

In the hybrid smelting system, induction coils and plasma field may work together. The plasma field may heat the contents from above, while the induction field heats the contents from below and around the contents. Each type of energy source may in this way heat different materials in the furnace (that is, the plasma field heats non-conductive materials and induction heats conductive materials). Both non-conductive materials and conductive materials may be heated together. They may be heated simultaneously. The hybrid smelting system thus overcomes the inefficiency of electric arc and blast furnaces which are restricted to non-conductive materials. The hybrid smelting system overcomes inefficiencies of induction furnaces which require carbon crucibles in order to provide magnetic coupling and enable the melting of non-conductive materials. Carbon crucibles are expensive and oxidize or deteriorate so require frequent replacement. As carbon crucibles deteriorate, they contaminate the produced molten metal with carbon, this is a significant disadvantage compared to the hybrid smelting system.

Efficiencies of the hybrid smelting system may extend to re-smelting whereby almost all residual metals are recovered from slag waste, and both the energy requirement and the carbon footprint is significantly reduced.

The hybrid smelting system may provide real-time monitoring and adjustment of the operating parameters. It may comprise sensors and it may comprise electronics to analyze and measurements and sensor feedback to provide real-time end-to-end management control over operating functions and the smelting process. This may enable calculation of an optimal reduction zone, and analysis of raw feed material. The feed material may be steered to pass directly through the plasma field.

The hybrid smelting system may comprise a mechanical manipulator to steer the feed material and/or the reduction zone. The hybrid smelting system may be configured to steer the feed material and/or the reduction zone by controlling the induction coils or a plasma generating device. The magnetic field or plasma field may be controlled to provide magnetic and/or electric fields which position the feed material and/or reduction zone.

The hybrid smelting system may measure and blend concentrate with reductant and flux, image of materials being processed in the furnace. The hybrid smelting system may measure and control smelting feed into the furnace; molten liquid level height inside the furnace, the plasma electrode height above the reduction zone, and power input into the plasma field and induction coils. These measures, blends and controls may maintain a set temperature inside the furnace, provide for continual tapping of materials, and granulation of finished products.

The hybrid smelting system may be configured to detect and monitor the level of content and/or indicate a predetermined level; instigate discharge of the molten slag at one or more out-feeds when the contents in the furnace reach a predetermined level; receive and continuously analyze information from a sensor and/or scanning system (e.g. for control batch analysis of the ore concentrate, temperature, discharge rate, the height of at least one agitator and temperature of heating elements integral to the agitator, configuration of one or more blades/susceptors for stirring).

Further disclosure of the hybrid smelting system, method, and furnace is provided in the claims.

The invention will now be described, by way of example only, with reference to the accompanying figures in which:

### BRIEF DESCRIPTION OF THE FIGURES

FIG. 1 shows a flow chart illustrating operative devices of a hybrid smelting system; and

FIG. 2 shows a schematic side cross sectional view of an induction smelting furnace to produce reduced metal and slag from infeed materials under the supervision of the hybrid smelting system.

### DETAILED DESCRIPTION OF THE INVENTION

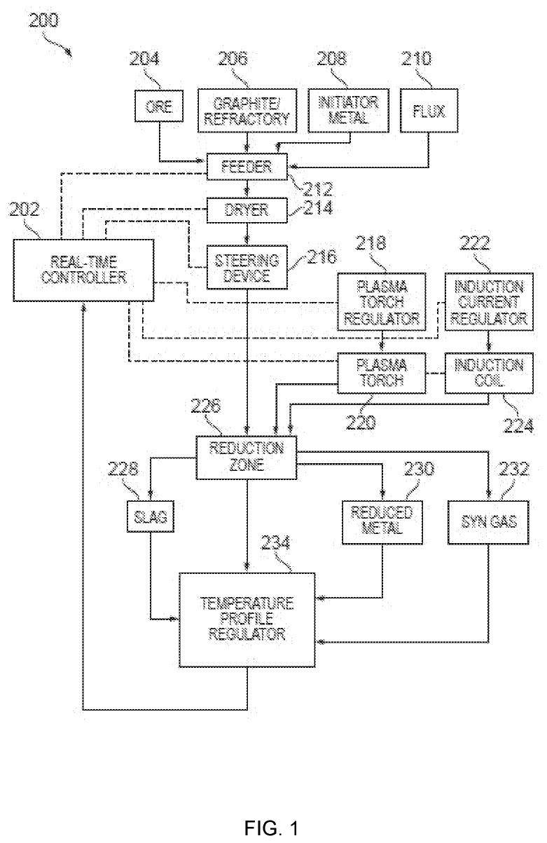

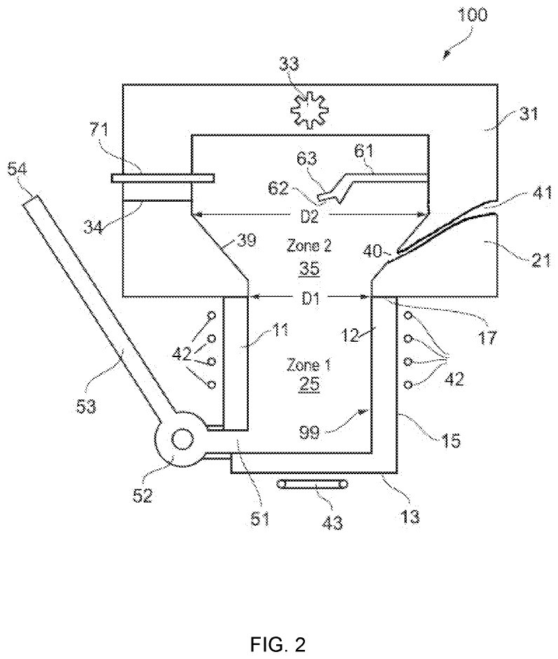

FIG. 1 shows a flow chart of a hybrid smelting process for a hybrid smelting system 200. FIG. 2 a hybrid smelting furnace 100 which is a part of the hybrid smelting system 200.

The flow chart in FIG. 1 shows how operative devices in the hybrid smelting system work together under the supervision of a real-time controller 202 to convert infeed materials comprising ore 204, graphite/refractory 206, initiator metal 208, and/or flux 210 to produce slag 228, reduced metal 230, and syngas 232.

A feeder 212 under the supervision of the real-time controller 202 supply into the reduction zone 226 the infeed material(s). A steering device 216 under the supervision of the real-time controller 202 steers feeder 212 to supply the infeed material(s) to pass directly through a hot plasma in the reduction zone 226.

The hot plasma is provided by a plasma torch 220 regulated by a plasma torch regulator 218 under the supervision of the real-time controller 202. Heat is also provided by an induction coil 224 which provides time varying magnetic flux in the reduction zone and below the plasma. An induction current regulator 222 regulates time varying current in the induction coil 224 under the supervision of the real-time controller 202.

A temperature profile generator 233 is in communication with thermometers, IR temperature sensors, and possibly other types of temperature sensors. A temperature profile generator 233 reads the temperature(s) of the reduced metal 230 below the slag 238, the slag 238 below the plasma 226, and syngas 232 produced in the plasma but not necessarily temperature sensed there. In this way the real-time controller 202 provides closed loop control to monitor and or operate at least one device including for example: a feeder 212, dryer 214, steering device 216, plasma torch regulator 218, plasma torch 220, induction current regulator 222, induction coil 224, reduction zone 226, weight sensor, and or temperature profile regulator 234. These devices are monitored and or controlled under the supervision of the real time controller.

One or more weight sensors monitor the weight of the infeed materials 204, 206, 208, 210 and slag 228, reduced metal 230, and syngas 232 in the reduction zone 226 and flowing out of conduits out of the reduction zone 226. The weight sensors are in real-time communication the real-time controller 202 to enable regulation of the feeder 212 and flow regulators in the conduits out of the reduction zone. An inflow/outflow mass balance is thereby controlled by the real-time controller 202 to enable the hybrid smelting system to operate.

Objectives of the hybrid smelting process illustrated by FIG. 1 and particularly use of the real time controller may include maintaining temperatures in molten metals and alloys, slag floating above the molten metals and alloys, and gasses contained above within preselected ranges of weights, concentrations, and or temperatures.

FIG. 2 illustrates a hybrid smelting furnace 100 which operates under the supervision of a real-time controller 202 in the hybrid smelting system 200.

The hybrid smelting furnace 100 comprises three zones. Zone one 25 is the lowest and in use contains primarily molten metals and alloys. Zone one 25 may also contain minor amounts of slag and gasses which float up to zone two 35. Zone one 25 is lower and underneath a zone two 35 where lighter slag floats above the molten metals and alloys. Molten metals and alloys that are produced in zone two 35 sink down into zone one 25. Gases that are produced in zone two 35 rise up through the slag into a covered space above the slag which is zone 3.

Zone three is primarily a reduction zone. Zone three is primarily the reduction zone 226 where reduction occurs under supervision of the real-time controller 202. Some reduction and other chemical reactions also occur in zone one 25 and zone two 35.

A feature of the hybrid smelting process 200 is that chemical reactions such as reduction of feed materials such as ore 204, graphite refractory 206, and flux 210 occur in zone 3 above the slag in zone two 35. This is because the plasma torch heats the feed materials quickly to reaction and reduction sustaining temperature ranges as they are fed into the covered space of zone three. Thus slag and molten metals and alloys are produced in zone 3 and sink down into the zones below.

As shown in FIG. 2 there is a container 99 for zone one 25 located at a lower portion of the smelting furnace 100. The container 99 comprises side walls 11, 12 and bottom floor 13 which form a reservoir first wall of the zone one 25. In the reservoir of zone one 25 are held molten metals and alloys.

There is an effluent opening 51 proximate the bottom floor 13. The effluent opening 51 is primarily to discharge molten metal from the bottom of zone one 25. Discharge is under supervision of the real-time controller 202 which regulates a valve or elevator 52 which elevates an effluent exit 54.

There is a ledge 17 at the top of the side walls 11, 12 of zone one 25. Resting on the ledge 17 is a second wall 21 of zone two 35. The second wall 21 has an inner surface 39. A funnel or a step down to zone one 25 is formed by the shape of the second wall 21. The zone two 35 has a funnel or step-down cross section formed by the inner surface 39 which is slanted and or stepped.

The second wall 21 inner surface 39 slants or steps down to a relatively narrow opening where the second wall 21 rests on the ledge 17. The width or diameter of the relatively narrow opening is indicated by dimension D1 inf FIG. 2. Zone two 35 opens into zone one 25 at the relatively narrow opening.

As shown in FIG. 2 there is a slag decanting spout entrance 40 into zone two 35 and slag decanting spout exit 41 of the hybrid smelting furnace 100. The slag decanting spout is a conduit through the second wall 21 for slag to be removed from zone two 35. The slag decanting spout a teapot spout rises from the lower spout entrance 40 up to the higher spout exit 41.

Molten slag is decanted through the from at or near the bottom of the zone two 35 where the spout entrance 40 is located in the inner surface 39. Since the spout entrance is near the bottom zone two 35, the conduit prevents the incoming smelting concentrate floating on the surface of the molten slag in zone two 35 from being discharged out the side of the furnace. This is a control feature that allows for continuous operation of the hybrid smelting furnace and hybrid smelting system verses a traditional batching method. Higher through put and higher energy efficiency is achieved.

From FIG. 2 it is possible to compare the thickness side walls 11, 12 and bottom floor 13 of zone one 25 to the thickness of the second wall 21 around zone two 35.

The second wall 21 around zone two 35 has a greater thickness relative to the side walls 11, 12.

An electric coil 42 surrounds and or is proximate the first wall 11, 12 to produce a time varying magnetic field in the first zone 25. The first wall 11, 12 must be thin enough to be substantially transparent to the magnetic field produced by the electric coil. The first wall 11, 12 must also be comprised of non-magnetic materials and non-electrically conductive materials so that the time varying magnetic field efficiently passes from the coils 42 through the first wall into zone one 25.

Similarly there is a second electric coil 43 below the floor 13 of zone one 25. The second electric coil 43 also produces a varying magnetic field in the first zone 25 This is to inductively heat the reduced metal 230 and/or the initiator metal 208 in the zone one 25.

The first wall 11, 12, and floor 13 may comprise channels or pipes proximate or on an exterior surface 15 of the container 99 which carry water, oil, or molten salt which is not electrically conductive. This liquid may be circulated to cool the first wall 11, 12, and floor 13.

The second wall 21 of zone two 25 is not required to be transparent to a time varying magnetic field because the slag in the zone two 35 is nonconductive and not inductively heated. The second wall 21 may comprise different materials from the materials in the first wall 11, 12, 13. The materials 21 in the second wall may be selected primarily for high temperature structural strength and the thermal insulation.

Reviewing FIG. 1 together with FIG. 2, the initiator metal 208 may be fed into the container and melted by the electric coil before the other infeed materials ore 204, graphite/refractory 206, and flux 210 to prime the furnace 100. An advantage of the hybrid smelting system 200 is that the initiator metal/alloy 208 is not necessary because the plasma produces reduced metal very soon after the other infeed metal are fed into the plasma. Thus a conductive metal is available for the time varying magnetic field to heat.

A cover 31 rests on a second ledge 34 of the second wall 21. The cover 31 to closes the container 99. A feeder 212, not shown in FIG. 2, has an access port through the cover 31 to feed materials including ore 204, graphite/refractory 206, initiator metal 208, and or flux 210 in a zone 3 above the zone two 35.

There is a torch 61 in the zone three under the cover 31. The torch 61 comprises an electrode 63 to produce an arc in the zone three to produce the plasma. The plasma torch 61 is disposed and displaceable above the level of the slag effluent opening 41 because the level of slag in zone two 35 is at or below the level of the slag effluent opening 41.

Reviewing FIG. 1 together with FIG. 2, the torch 61 is moveable in the interior of the container 99 from below the slag effluent opening 41 to above the slag effluent opening 41 and vice versa. There is also a steering device 216 to steer the feed material to the torch 61. The steering device 216 may be supported by the cover 31. The feed materials: ore 204, graphite refractory, 205, and flux 210 are heated by the plasma in zone three where they undergo chemical reactions and reduction to produce the slag which sinks down to zone two 35 and to produce molten metal and alloy which sinks to zone one 25.

Induced electric currents maintain the molten metals in zone one 25 above their melting temperatures.

Initially an initiator metal/alloy 208 may be loaded into zone one 25 and heated inductively. Although the initiator metal/alloy 208 is not necessary because of the high temperature plasma torch in zone three which produces molten metal and alloy from the feed materials.

In an embodiment the hybrid smelting system 200 shown in FIG. 1 controls an induction hybrid smelting system comprising induction furnace technology known as an Inducto-smelt Reduction Furnace (IRF) as shown in zone one 25 and zone two 35 of FIG. 2.

An IRF is configured to receive feed material (such term to include lumpy ore, blended powders, smelting concentrates and pelletized concentrates). However in the hybrid smelting system 200, there is a hybrid smelting furnace as shown in FIG. 2. The hybrid smelting furnace comprises a feed system to introduce feed material into the zone three of the furnace through a furnace inlet. In the hybrid smelting system there is below zone three an upper slag zone which is the zone two 35. Below zone two 35 is a lower molten metal zone which is the zone one 25.

The hybrid smelting system comprises induction coils to transmit energy into the molten metal in the zone one 25 to heat the molten metal keep the slag at the same or similar temperature as the molten metal, avoiding furnace “freeze”), Thus the plasma torch 61 may be reduced after initially heating and reducing the feed materials 204, 206, 210. There is also radiant heat transfer to the slag in zone two 35 from the molten metal in zone one 25 keeping the slag in a safe, molten, and low viscosity liquid state.

The hybrid smelting system 200 comprises a plasma energy source transmits energy via the plasma torch electrode 63 into the slag.

The hybrid smelting system 200 combines heating the feed materials of ore 204, graphite/refractory 206, initiator metal 208 and flux 210 within the furnace, the feed materials being heated directly via electromagnetic induction from the coils 41, 43 proximate the zone one 25. Also there is subsequent joule heating (e.g. for conductive contents), and radiant heat transfer from both the molten pool of metal and the plasma energy source (e.g. for non-conductive contents).

In an illustrative embodiment the hybrid smelting system shown by FIGS. 1 and 2 in combination comprises sensors and electrical systems configured for monitoring and adjusting IRF operating parameters including

1i/Monitoring the drying of raw concentrate with a dryer 214 as it passes through a rotary drying kiln. The raw material may comprise refractory metals and ores of refractory metals selected from titanium, vanadium, chromium, niobium, molybdenum, zirconium, ruthenium, rhodium, tantalum, tungsten, rhenium, osmium, iridium, and alloys that contain these refractory metals; reactive metals selected from zirconium, titanium and beryllium and alloys comprising these metals. The raw material may also comprise recovered fine chrome units in the form of chromite, chrome rich spinel, and ferrochrome metal. The raw material may comprise graphite or components comprising graphite infiltrated or contaminated with refractory metals.

1ii/Adjusting the temperature and speed of a rotary drying kiln to dry the raw concentrate down to for example less than 1% moisture content;

2/Analyzing the feed concentrate of ore 204, graphite/refractory 206, initiator metal 208. Analyzing is done for example as the dried raw concentrate is conveyed into a batching mixer. The feed concentrate passes through an on-belt elemental analysis system. The hybrid smelting system receives analysis of the feed concentrate (e.g. via a technique such as Prompt Gamma Neutron Activation Analysis (PGNAA)), which shows the percentage of key elements in the concentrate, including the oxygen, carbon, and sulfur contents. The hybrid smelting system calculates accurately the quantity of flux 210 and reductant to be dispensed along with the feed concentrate of ore 204, graphite refractory 206, and or initiatory metal 208 into a mixing vessel prior to being fed into a hybrid furnace such shown in FIG. 2;

3/Receiving weight measurements from the mixing vessel, determining the amount of concentrate of ore 204, graphite/refractory 206, and or initiator metal 208, and determining amount of flux 210, and reductant discharging into the mixing vessel and controlling the screw feeds that dispense the flux and reductant;

4/Monitoring simultaneously and controlling the rate at which a feed system 214, for example a screw feed injection system (SFIS) injects the smelting concentrate into the IRF unit and other factors including:

4/(i) Operating internal thermal processes and mechanical operation of the hybrid smelting furnace— a backscatter scanning system (BSS) located along the side of the hybrid smelting furnace unit scans zone one 25 and zone two 35 system from top to bottom, providing detailed real time “x-ray” images of the internal thermal processes and mechanical operation of the IRF. The hybrid smelting system 200, and in particular the real time controller 202, uses this information to calculate the molten metal and slag level inside the IRF unit and in particular zone one 25 and zone two 35. This information is also used to control the height and power level of the plasma field, rate of smelting concentrate injection, and rate of molten metal discharge. The hybrid smelting system also displays real time “x-ray” images on the control screen for the operators to observe and oversee the management and movement of materials through the IRF unit;

4/(ii) Confirming quantity of injected smelting concentrate—the IRF unit comprising zone one 25 and zone two 35 is mounted on load cells that confirm the amount of smelting concentrate being injected by the screw feed injection system and reports this information to the hybrid smelting system 200 and in particular the real time controller 202;

4/(iii) Generating temperature profiles— thermocouples imbedded in the furnace liner provide temperature readings from the liquid metal at the bottom of the IRF in zone one 25, temperatures from the reaction zone in the middle of the IRF in zone one 25, and temperatures from the slag zone in zone two 35 at the top of the IRF below zone three. The hybrid smelting system 200 and in particular the real time controller 202 uses this information to generate one or more temperature profiles in order to regulate the rpm of the screw feed injection system, which controls the feed rate of smelting concentrate;

5/Monitoring and controlling the power input into the plasma field produce by the plasma electrode 63 in zone three and the multiple induction coil zones of the coils 41, 43. This is done for example through temperature feedback to the real time controller 202 from the thermocouples embedded in the furnace liner side walls 11, 12, floor 13, and second wall 21, the temperature of discharged molten metal and slag is also monitored by thermocouples in the second wall proximate the decanting spout entrance 41 and exit 41 and the molten metal effluent conduit 53. The hybrid smelting system 200 references processing temperatures for the materials being smelted and uses this information as a baseline control parameter thus accurately controlling the temperature in zone one 25, zone two 35, and zone three. Over-powering or under-powering the plasma field and induction coils as smelting feed is injected into the furnace is avoided.

6/Controlling the liquid level of molten metal in zone one 25 and slag zone two 35. Molten slag may temporarily sink into zone one 25 as molten metal is removed from the molten metal conduit 53. Molten metal may temporarily rise into zone two 35 if insufficient molten metal is withdrawn from zone one 25 through the molten metal effluent conduit 53 to prevent overflow of the molten metal. Feedback from the IRF back scatter scanning system (BSS) and load cell to the real time controller 202 ensures that the rate of feed materials in and discharge for slag and molten metal is proper to maintain molten metal in zone one 25 slag in zone two 35. The hybrid smelting system 200 monitors the rate of concentrate injection, the rate of slag and metal discharge, and the level of molten metal in the IRF. When the level of molten metal reaches a predetermined set point, for example the maximum set point, the hybrid smelting system opens the molten metal discharge valve 52 at the bottom of the IRF unit in zone one 25 and discharges molten metal at a controlled rate to maintain the optimal molten metal level in the IRF unit.

7/Monitoring the rate of molten metal discharge into a water granulation system so that it can control the temperature and flow rate of the granulation water in the system. The water granulation system freezes sprayed droplets the molten metal discharged out of exit 54 the molten metal effluent conduit 53. In the water granulation system there is a pool of water which instantly quenches the droplets into granules.

8i/Monitoring the rate of the molten slag discharge out through second wall exit 41.

8ii/Controlling the air pressure and water injection rate into the slag of molten slag which pours out of molten slag exit 41 to flow into a granulation nozzle, for example, to produce spinel prills.

It is a further advantage of the hybrid smelting system 200 that, in monitoring the operating parameters of the sensors and devices in it that, the hybrid smelting system 200 ensures safe operation within the design parameters of the system. The real time controller 202 will trigger communicators to alert the operators if any of the set control parameters are breached and/or automatically start controlled shut down procedures.

In an embodiment the slag zone two 35 is kept at the same or similar temperature as the molten metal in zone one 25 to avoid furnace “freeze” by having induction coils transmitting energy into the molten metal and through radiant heat transfer to the slag keeping it in a safe, molten, and low viscosity liquid state.

A plasma energy source 61 transmits energy into the slag in zone two 35 below a plasma electrode 63. The level of the slag surface is maintained within a range by feedback from the real time controller 202 to a slag exit 41 valve or furnace tipper, and by feedback from the real time controller 202 to a molten metal effluent valve or tipper 52.

The hybrid smelting system 200 combines heating the feed materials within the furnace 100, the feed materials being heated directly via electromagnetic induction from coils 41, 43 and subsequent joule heating (for example, for conductive contents), and radiant heat transfer from both the molten pool of metal and the plasma energy source (for example, for non-conductive contents).

In a preferred embodiment, thermal energy transfer system enables the high efficiency of induction furnace technology to be used for primary smelting of non-conductive materials through the addition of a plasma field at the top of the furnace to heat and maintain the slag generated during smelting in a molten form. The slag head is kept at the same temperature as the molten metal, eliminating dangerous furnace “freeze” situations by heating the non-conductive slag with a plasma field and the conductive metal with the induction field.

Whilst addressing the drawbacks of a traditional induction furnace smelting by effecting a super-efficient primary smelting furnace capable of smelting non-conductive materials, the hybrid smelting system further keeps the slag head heated. The induction heating creates an electro-magnetic stirring action thereby optimizing the smelting environment to reduce metal oxides into metal.

Among the non-electrically conductive materials are materials that are typically difficult to inductively heat for which processes may have relied on low efficiency electric arc or blast furnaces, or traditional induction furnaces fitted with carbon crucibles.

In further embodiments, the IRF hybrid smelting system is effective for smelting: recovered fine chrome units in the form of chromite, chrome rich spinel, and ferrochrome metal from a raw material.

According to each desired product, the hybrid smelting system determines and adjusts the reductants, fluxes, blend ratios and reactions for each raw material and/or output metal. The raw feed is dried to a concentrate before being sent to be mixed with the reductant and flux. The concentrate is analyzed to determine its particular composition or make up (that is, the ratio and composition of the feed material). The characteristics of the composition or make-up is then used to determine the quantity of reductant and flux to be added to the concentrate.

The molten metal produced may be a pure (or substantially pure) single metal or an alloy comprising two or more metals, depending on the composition of the blend/feeding material.

In an embodiment, the IRF hybrid smelting system 200 comprises an electrode plasma torch assembly 61, 62, 63 comprising two/twin electrodes 63 spaced apart, forming a plasma field between the electrodes when the torch is activated. The plasma field is formed at or towards the lower ends of the electrodes, the lower ends of the twin electrodes being positioned towards each other in a V-shape to form the plasma field between the lower ends of the electrodes.

In an embodiment, the twin electrodes 63 (extending through the lid of the furnace to the bottom) generate a moveable plasma field by an electrical arc ionizing a working gas into plasma: for example, nitrogen gas is supplied to the tips 62 of the electrodes to ionize the electrical arc that passes between the electrodes generating the ultra-high temperature plasma field. The nitrogen gas also provides an inert atmosphere in the furnace (to prevent oxidation of the produced molten metal in the furnace).

The nitrogen consumption of the hybrid smelting system 200 in the preferred configurations can be 90% less than a typical plasma torch (which requires a pressurized stream of working gas to operate).

The hybrid smelting system powers the plasma torch 61 up or down to increase or decrease the physical size and the amount of thermal energy that radiates from the plasma field to the surrounding environment.

As the feed material passes through the plasma field, the material is converted to its molten form. An ultra-high temperature reduction environment cracks the ore matrix (for example, silica/alumina) that encapsulates the targeted ore/metal oxides, thus exposing the ore/metal oxide to reductant in the feed material, optimizing the metal yield from the smelting concentrate.

The ultra-high temperature plasma field in preferred configurations enables rapid smelting of the feed material contents in two ways. First, as the feed material passes through the plasma field the feed material is heated and turned into a molten state. The molten content accumulates onto the surface of the molten slag and reduction zone directly below the plasma field. Second, plasma field positioned directly above the surface of the slag, provides direct thermal energy to the slag to form a high temperature reduction zone and keeps the slag liquid.

The molten metal has a higher specific gravity than the molten slag and sinks towards the bottom of the furnace where it forms a pool of molten metal that electromagnetically couples with the induction field (created by the induction coils 41, 43). The induction field (located below and/or around the molten contents) keeps the molten metal hot and induces a vertical stirring action in the molten metal.

The stirring action generated by the induction field promotes reduction of the smelting contents by circulating micro units of reductant and metal oxide through the metal bath, providing physical contact between the particles.

The heating provided by the plasma torch assembly 61, 62, 63 can provide an even temperature profile in the hybrid smelting furnace 100 and particularly in zone one 25 and or zone two 35. The stirring helps homogenize the materials being smelted (or melted). The even temperature profile helps improve the metal yield. The extreme temperature and prolonged reduction zone of the IRF system enables complete (or at least improved) reduction of metal oxides into valuable metal. Further, it promotes homogenous metal alloy when working with compound alloys like ferrochrome, ferromanganese, etc.

The dual heat source from the induction coils 41, 43 and plasma field around electrode 63 work in synergy to efficiently smelt both conductive and non-conductive materials. In one embodiment there are twin electrodes including first electrode 63 and a twin second electrode. The second electrode is not shown in FIG. 2. There a plasma arc produced between the twin electrodes which is move (either or both in a vertical direction and angularly with respect to the furnace) under command from the real time controller 202. The size and/or location of the plasma field can be controlled to further increase efficiencies and/or effective heating of the molten contents.

In a preferred configuration, the plasma torch assembly 61, 62, 63, which may comprise twin electrodes, forms a plasma ball between 50 mm (for example, during low power start-up) and 400 mm (for example, at high power full production) in diameter.

The hybrid smelting system 200 controls the current fed to the electrodes thereby controlling the size and intensity of the plasma field between the two electrodes. For example, a starting current of approximately 20 KW forms the smallest plasma field of approximately 50 mm, 500 KW forms a plasma field of approximately 300 mm in diameter, and the power is increased to 700 KW to produce a plasma field of approximately 420 mm in diameter.

The hybrid smelting system controls 200 the distance of the plasma torch assembly 61, 62, 63 and in particular the electrode 63 from the surface of the molten slag in zone two 35, that is, to keep the molten slag directly below the plasma field in the reduction zone and the surrounding slag zone in a safe and low viscosity state.

When initiating a smelt in the hybrid smelting system 200, the electrode(s) 63 is/are extended down into the induction furnace to an initial distance (for example, 200 mm) from the bottom floor 13, thus smelting can commence without the use of a conductive ingot of initiator metal to electromagnetically couple with the induction furnace and create a starting pool of conductive molten metal and slag.

As the pool of molten slag and metal rise within the furnace, the electrode(s) 63 is/are raised, and the plasma field is increased to a designed operating level to facilitate continuous production.

The hybrid smelting system 200 further monitors the rate of electrode 63 erosion and extends the electrode(s) 63 into the furnace to maintain the distance between the plasma field and the surface of the slag in the zone two 35 during operation.

A feed injector system is vertically or horizontally aligned, moveable and adjustable according to start-up purpose.

A screw feed injection system can be further configured to compact/compress the feed material to regulate the rate of thermochemical reduction by limiting the total surface area and to then feed compacted feed materials into the furnace chamber. The compaction of the feed material by a screw feed injection system can for example reduce the need to agglomerate fine concentrate, reductant, and flux prior to entry into the screw feed injection system.

In the preferred configurations, the hybrid smelting system provides pelletized feed material: binderless pellets of homogenized smelting concentrate that reduce 30% faster in the hybrid smelting system in comparison to smelting concentrate powder. The accelerated reduction is driven by the metal oxide being in close and or direct contact with the reductant and flux. The use of homogenized smelting pellets in the hybrid smelting system furnace reduces the external power input by approximately 30%.

Pelletizing the smelting concentrate into hard pellets also provides the ability to drop-feed the pellets directly into the ultra-high temperature plasma field which, exposes the smelting pellets to about 10,000° C. for a few milliseconds.

Pelletizing the smelting concentrate further avoids the problem that, were the smelting concentrate not pelletized, it may not pass through the plasma field but rather be deflected by the field and settle along the edges of the chamber and on the surface of the slag zone within the furnace.

The hybrid smelting system 200 adjusts one or more molten content out-feeds, for example a molten metal discharge conduit 54, by operating an actuator 52 which acts a flow control valve by raising and lowering exit 54 between a raised and lowered discharge position to adjust the rate of molten content discharge. The hybrid smelting system tracks the molten metal (referred to as content 1) level in the furnace and adjusts the height of the content 1 out-feed to speed up or slow down the rate of content discharge from the furnace. This feature gives the system 200 the flexibility to enable smelting of most ores and customised concentrates with varying amounts of slag, while still maintaining the required balance between the reduction zone particular in zone 3, slag zone particularly in zone two 35, and the molten metal zone particularly in zone one 25 to ensure the safe and continuous operation of the hybrid smelting system 200.

In an embodiment, the hybrid smelting system 200 can control the contents in the furnace by way of opening or closing a high temperature discharge valve located in the bottom region of the furnace.

In an embodiment, the hybrid smelting system controls the feed rate by the mass balance of the furnace. As materials exit the furnace body, the screw feeder speeds up and injects more into the furnace, particularly into zone three. In measuring the infeed rate (through load cells that the furnace body is mounted on) and the out-feed rate (by load cells that are attached to the molten metal granulator and the slag granulator) the hybrid smelting system continuously produces a real-time mass balance of the system that also includes the CO and CO2 off gas generated by the reduction agent.

The hybrid smelting system 200 also calculates from the back scatter scanning system (BSS) how the concentrate, reductant, and flux are reacting and flowing within the system and differences in density of the molten metal, interface, and molten slag zones inside the furnace thus the interface is kept in the centre of the feed materials injection zone.

The angle of the out-feeds, for example molten metal discharge conduit 53 can be adjusted in real-time by the real time controller 202, to compensate for different metal to slag ratios. A second molten content out-feed with exit 41 is located, for example above the first molten content out-feed 53, to allow molten slag discharge to be discharged from the slag zone two 35 at a predetermined level. Thus the molten slag and metal are discharged into two separate induction heated launders that transports the molten materials to granulation systems.

In an embodiment, the hybrid smelting system functions comprise one or more the following:
the temperature and/or speed of dryer
dosing of concentrate, reductant and/or flux into a mixing system;
speed of feed system;
power input of the twin electrode plasma torch assembly;
movement of the two electrodes;
power input of the induction coils;
movement of the molten content out-feeds;
injection rate of feed material;
height of the one or more of the out-feeds;
water-cooling in screw feed injection system;
water-cooling in the induction coils, and
air pressure and water injection rate into the slag granulation nozzle to produce spinal prills.

The hybrid smelting system 200 receives information from one or more of the following to adjust the controls:
concentration or chemical analysis of dried raw concentrate;
temperature sensors (e.g. thermocouples, infrared sensors);
weight sensors;
a level system to determine the level of slag and/or molten metal;
backscatter X-Ray unit providing real-time image of slag, metal, and plasma torch height;
rate of molten slag discharge.

Preferably, the hybrid smelting system adjusts the smelting rate of the system by controlling one or more of: rate of feed material entering the furnace; rate of molten slag discharge; and heating by induction or plasma.

The dried raw concentrate is conveyed into a mixing vessel. As the concentrate is conveyed to the mixer, the concentrate passes through a Prompt Gamma Neutron Activation Analysis PGNAA machine. The PGNAA analyses the concentrate in real time to provide the hybrid smelting system with analysis data of the reactant materials as well other materials that make up the concentrate. This data is then used by the hybrid smelting system to determine the percentage (weight, volume and/or ratio) of key elements that make up the concentrate, including one or more of the oxygen, carbon, phosphorus, and sulfur content. The analysis data is used by the hybrid smelting system to determine the correct amount of flux and reductant to add to the concentrate in the mixing vessel. This correct amount of flux and reductant will lead to ideal smelting conditions for characteristics of the concentrate.

Raw material, reductant, and flux of various particle sizes are suitable for use in the improved hybrid smelting system 200. It will be appreciated that the particle size of the various ingredients of the blend can affect the rate of melting and/or reaction. Suitable size ranges can be determined.

By analyzing the concentrate continuously as it is going to, or into, the mixer, the hybrid smelting system 200 quantifies the amount of each reactant material entering the mixer. The Prompt Gamma Neutron Activation Analysis PGNAA system is equipped with a microwave moisture analyzer to determine water content. A conveyor passing through the PGNAA is equipped with weight cells to determine the mass flow rate of the conveyed material. The PGNAA unit transmits this information to the hybrid smelting system.

Thus, the hybrid smelting system 200 comprises means for one or more of the following in effecting a super-efficient continuous smelting process:
an accurate approximation and continuous readings of the raw material/concentrate composition;
formation of the feed material;
the rate of feed material injection into the furnace 100;
control of the power input into the plasma field produced by plasma torch 61 and metal zone induction coil(s) 41, 43;
control of the molten level of the contents;
control of the rate of the molten slag discharge, air pressure and water rate into the slag granulation nozzle;
automatic adjustment and/or shut down procedures if parameters are breached and generate an alert to an operator;
management of the configuration of the stirrers; and/or
management of the heatable members'

An accurate approximation and continuous readings of the raw material/concentrate composition may include real time analysis of the concentrate. This allows the hybrid smelting system 200 to determine exactly the chemical composition and weight of the concentrate that is being delivered to the furnace feed hopper. This is compared to other methods, such as taking samples of the concentrate occasionally, and extrapolating the approximate composition of the entire concentrate batch. This batch mixing to form a blended concentrate (feed material) that can then be fed into a furnace feed hopper. The furnace feed hopper can even out the flow rate of the batch mixing process. So the hybrid smelting furnace 100 can act in a continuous fashion.

Formation of the feed material is provided once the flux, reductant and concentrate has been mixed together. The mixture forms the feed material which is stored in a furnace feed hopper.

Control of the power input into the plasma field and metal zone induction coil also allows the hybrid smelting system 200 to keep a temperature profile consistent across the face of the refractory liner, for example in floor 13 and side walls 11, 12 of the zone one 25 and second wall 21 in the furnace 100. This prevents the refractory liner from cracking due to differences in temperatures in difference regions of the furnace. The control of the power input is done by temperature feedback from thermocouples and backup infrared sensors into the real time controller 202 which in turn controls the feeder 212, molten metal discharge valve 52, slag exit 41 or tipper, coil 41, 43 current and frequency, plasma torch power, and so forth devices.

The contents once smelted, forms molten metal and slag. Depending on the level of molten metal, the hybrid smelting system 200 adjusts the height of the out-feed of the molten content. The hybrid smelting system 200 also monitors the rate of feed materials injection, and the rate of slag discharge from the slag out-feed, to control the level (i.e. volume) of molten metal in the furnace.

The hybrid smelting system 200 enables an increase in metal yield of 35% or more with some ores and concentrates.

The hybrid smelting system 200 enables a reduction in energy demands of primary ore smelting by a minimum of 58%. This is due to the ultra-high temperatures of the plasma field and its extended exposure to the reduction zone.

The hybrid smelting system 200 enables an increased speed of smelting and separating the slag away from the produced metal units. To do this the hybrid smelting system monitors and maintains the slag in a low viscosity state and continuously decants out the side of the IRF system while the molten metal units collect in the induction heated bottom section of the IRF system.

The hybrid smelting system 200 enables the handling of high slag loadings without inhibiting efficient production of metals.

The hybrid smelting system 200 enables the smelting of ultra-fine powered concentrates, agglomerated materials, and lumpy materials (up to 40 mm or larger). The hybrid smelting system provides for an operating flexibility that enables the IRF hybrid smelting system to effectively transition between the processing of raw material feeds or the blending of different size fractions; taking advantage of the fine ore concentrate by blending in the reduction agent and flux to produce a homogenized mixture that increases the efficiency of the smelting process.

The hybrid smelting system 200 enables a time saving of approximately 30% as continuous tapping eradicates time normally used for furnace tilting or tapping procedures. This saves up to 300 kWh per hour or 7200 kWh per 24 hours of operation.

Using the hybrid smelting system 200 up to 30% of the waste heat energy normally lost from traditional furnace technologies is recovered. The recovered thermal energy is reused to pre-heat feed material in preparation for smelting. This reduces further the energy demand, the carbon footprint and significantly improves the operating efficiencies of the smelting process.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

1. A hybrid smelting system (200) comprising a real-time controller (202) and a reduction zone (226) in which plasma over induction heating continuously smelt feed material(s) (204, 206, 208, 210) that are fed into the reduction zone (226) and slag and reduced metal(s) and or alloy(s) that are discharged under supervision of the real-time controller (202).

2. The hybrid smelting system (200) according to claim 1 comprising a feeder (212) operating under supervision of the real-time controller (202) to supply into the reduction zone (226) the feed material(s) (204, 206, 208, 210) in a form of debris, detritus, or dross ranging from ultra-fine powder or sand up to lumps of 40 mm or greater.

3. The hybrid smelting system (200) according to claim 1 comprising a steering device (216) which operates under the supervision of the real-time controller (202) to steer at least one feeder (212) to supply the feed material(s) to pass directly through the plasma into the reduction zone.

4. The hybrid smelting system (200) according to claim 2 comprising a reduced metal discharge regulator (52) and a slag discharge regulator (33, 41) which both operate under supervision of the real-time controller (202) in conjunction with the feeder to keep a first level of the reduced metal(s)/alloy(s) within a first preselected range in a zone one (25) and/or to keep a second level of the slag within a second preselected range in a zone two (35).

5. (canceled)

6. The hybrid smelting system (200) according to claim 1 comprising a plasma torch displacement actuator which operates under supervision of the real-time controller (202) to position a plasma torch (61) to produce the plasma in the reduction zone (226) immediately over the slag to keep a viscosity of the slag within a preselected range.

7. (canceled)

8. The hybrid smelting system (200) according to claim 1 comprising a plasma current regulator which operates under supervision of the real-time controller (202) to control size, temperature, particle density and/or light intensity of the plasma.

9. The hybrid smelting system (200) according to claim 8 wherein the plasma current regulator is operative to provide a starting current to provide approximately 20 kW power into the plasma and form a plasma field 45 mm to 55 mm in diameter.

10. (canceled)

11. The hybrid smelting system (200) according to claim 1 comprising an induction current regulator which operates under supervision of the real-time controller (202) to control a fourth current in an induction coil (41, 43).

12. The hybrid smelting system (200) according to claim 1 operative to maintain temperature(s) within the reduction zone (226), slag, and/or reduced metal, to provide for continual tapping of molten materials, and granulation of finished products.

13-14. (canceled)

15. The hybrid smelting system (200) according to claim operative to prolong the temperature(s) in the reduction zone (228) to reduce metal oxides comprising recovered fine chrome units, chromite, chrome rich spinel, and/or ferrochrome in the feed material(s) into homogeneous metal alloy comprising iron, chromium, and/or manganese.

16. (canceled)

17. The hybrid smelting system (200) according to claim 1 configured to maintain the mean temperature of the plasma in a range of 3500° C. to 12000° C. to change organic solid compounds in the feed materials into raw syngas.

18. The hybrid smelting system (200) according to claim 1 configured to maintain the reduced metal and slag in a temperature range between 1700° C. and 2800° C.

19. The hybrid smelting system (200) according to claim 1 configured to smelt feed material(s) comprising: titanium, vanadium, chromium, niobium, molybdenum, zirconium, ruthenium, rhodium, tantalum, tungsten, rhenium, osmium, and/or iridium, and/or alloys and/or ores that contain these refractory metals.

20. (canceled)

21. A hybrid smelting furnace (100) for operating in a hybrid smelting system (200), comprising a container (99) of a reduction zone (226), the container (99) comprising an electric field transparent first wall (11, 12) to hold and inductively heat metal(s) and or alloy(s) above a molten metal/alloy effluent opening (51) though the container (99); a second wall (21) having a greater thickness relative to the first wall (11, 12) to hold slag above the first wall up a to slag effluent opening (41) through the container (99); and a plasma torch (61) disposable above a level of the slag effluent opening (41) to heat and reduce feed materials to produce the metals or alloys and the slag.

22. (canceled)

23. The hybrid smelting furnace (100) according to claim 21 wherein the container 99 has an interior cross section area which increases progressively or intermittently from where the first wall (11) meets the second wall (21) (D1) up to the level of the slag effluent opening (41) (D2).

24. The hybrid smelting furnace (100) according to claim 21 comprising an electric coil (42) proximate the first wall (11) to produce a time varying magnetic field in a first zone (25) in the container 99 surrounded by the first wall (11) to inductively heat the metal.

25-29. (canceled)

30. The hybrid smelting furnace (100) according to claim 21 wherein the torch (61) comprises an electrode (63) to produce an arc in the container (99).

31. The hybrid smelting furnace (100) according to claim 21 wherein the torch (61) is moveable in the interior of the container (99) from below the slag effluent opening (41) to above the slag effluent opening (41) and vice versa.

32. The hybrid smelting furnace (100) according to claim 1 wherein the torch (61) is moveable in the interior of the container (99) above the slag effluent opening (41) to or from a first zone (25) in the container (99) bordered by the first wall (11, 12) and below the second wall (21).

33-40. (canceled)

41. The hybrid smelting furnace (100) according to claim 21 wherein comprising a gas injector (71) above the slag effluent opening (41) to inject gas above a level of slag.

42. (canceled)
